(19) United States
(12) Patent Application Publication
(10) Pub. No.: US 2025/0079551 A1
(43) Pub. Date: Mar. 6, 2025

(54) APPARATUS AND METHOD FOR CONTROLLING BATTERY THERMAL MANAGEMENT OF A VEHICLE

(71) Applicants: HYUNDAI MOTOR COMPANY, Seoul (KR); KIA CORPORATION, Seoul (KR)

(72) Inventors: Yoon Cheol Jeon, Suwon-si (KR); Jong Pil Kim, Suwon-si (KR)

(73) Assignees: HYUNDAI MOTOR COMPANY, Seoul (KR); KIA CORPORATION, Seoul (KR)

(21) Appl. No.: 18/507,767

(22) Filed: Nov. 13, 2023

(30) Foreign Application Priority Data
Aug. 29, 2023 (KR) 10-2023-0114012

(51) Int. Cl. H01M 10/63; H01M 10/48

(52) U.S. Cl. CPC H01M 10/63; H01M 10/482; H01M 10/486; H01M 10/615; H01M 10/625; H01M 2220/20

(57) ABSTRACT

An apparatus and method for controlling battery thermal management of a vehicle include at least one sensor that detects a temperature and a voltage of a plurality of battery cells in a battery module, a heating device that generates heat, and a processor that controls an operation of the heating device based on a location in which thermal runaway occurs in the battery module when determining that the thermal runaway occurs in the battery cell of the plurality of battery cells located within the battery module based on the temperature and the voltage of the battery cell.

### CROSS-REFERENCE TO RELATED APPLICATION

This application claims the benefit of and priority to Korean Patent Application No. 10-2023-0114012, filed on Aug. 29, 2023, the entire contents of which are incorporated herein by reference.

### TECHNICAL FIELD

The present disclosure relates to an apparatus and method for controlling battery thermal management of a vehicle. More specifically, the present disclosure relates to an apparatus and method for controlling battery thermal management of a vehicle that can prevent thermal runaway of a battery from spreading.

### BACKGROUND

The statements in this section merely provide background information related to the present disclosure and may not constitute prior art.

Batteries that supply power for the driving and operation of electric vehicles require high voltage and high capacity. To this end, a battery in an electric vehicle is mounted as battery packs formed by combining multiple modules, each of which is provided with multiple battery cells.

Thermal runaway may occur in a battery mounted on a vehicle due to mechanical abuse such as battery cell deformation or penetration during an external collision, electrical abuse such as an external short circuit in a battery cell, overcharging or over-discharging, thermal abuse from an external heat source, or the like. Although the causes of thermal runaway are diverse, damage to a separator may cause an internal short circuit between the anode and cathode, causing a large amount of heat to spread sequentially to surrounding battery cells.

The spread of thermal runaway of battery cells within a battery module may cause thermal runaway to neighboring battery modules. Therefore, a thermal barrier is provided between battery modules to prevent the spread of thermal runaway. There is a trend of increasing the thickness of a thermal barrier to improve the insulation effect. However, as the thickness of the thermal barrier increases, the vehicle weight increases, which causes a decrease in driving distance.

### SUMMARY

An aspect of the present disclosure provides an apparatus and method for controlling battery thermal management of a vehicle, which can prevent thermal runaway from spreading to neighboring battery modules even when thermal runaway occurs in a battery cell.

Embodiments of the present disclosure provide an apparatus and a method for controlling battery thermal management of a vehicle, which includes a heating device provided near, i.e., in the vicinity of, a thermal barrier of a battery module, and can identify the location of the battery cell in which thermal runaway occurs within the battery module, and operate the heating device located in the opposite direction of the thermal runaway direction to reduce or minimize thermal effects of the thermal barrier located on the outside of the battery module and prevents thermal runaway from spreading to surrounding battery modules.

Another aspect of the present disclosure provides an apparatus and a method for controlling battery thermal management of a vehicle, which includes a heating device provided near a thermal barrier of a battery module, and can prevent thermal runaway from spreading, such that it is possible to minimize an increase in the thickness of the thermal barrier, thereby enabling a lightweight design of the battery module and improving vehicle fuel efficiency.

The technical problems to be solved by the present disclosure are not limited to the aforementioned problems. Any other technical problems not mentioned herein should be clearly understood from the following description by those of ordinary skill in the art to which the present disclosure pertains.

According to an aspect of the present disclosure, an apparatus for controlling battery thermal management of a vehicle includes at least one sensor that detects a temperature and a voltage of a plurality of battery cells in a battery module, a heating device that generates heat, and a processor that controls an operation of the heating device based on a location in which thermal runaway occurs in the battery module when determining that the thermal runaway occurs in a battery cell of the plurality of battery cells located within the battery module based on the temperature and the voltage of the battery cell.

According to an embodiment, the processor may set a first area and a second area of the battery module by dividing an entire area of the battery module based on a central battery cell provided in the battery module.

According to an embodiment, the heating device may include a first heating device provided in the first area and a second heating device provided in the second area.

According to an embodiment, the processor may control the second heating device provided in the second area to generate heat when the thermal runaway of the battery cell occurs in the first area.

According to an embodiment, the processor may control the first heating device provided in the first area to generate heat when the thermal runaway of the battery cell occurs in the second area.

According to an embodiment, the processor may identify a temperature change and a voltage change of the battery cell after an operation of the heating device is controlled.

According to an embodiment, the processor may determine whether the temperature of the battery cell increases simultaneously in a first area and a second area of the battery module.

According to an embodiment, the processor may monitor the temperature of the battery cell during a specified time period of time when determining that the temperature of the battery cell increases simultaneously in the first area and the second area.

According to an embodiment, the processor may monitor the temperature of the battery cell during the specified time period to determine whether the temperature of the battery cell decreases.

According to an embodiment, the processor may control an output device of the vehicle to output a guidance message to a user when determining that the temperature of the battery cell does not decrease.

According to an aspect of the present disclosure, a method of controlling battery thermal management of a vehicle includes detecting a temperature and a voltage of a plurality of battery cells in a battery module. The method further includes controlling an operation of a heating device based on a location in which thermal runaway occurs in the battery module when determining that the thermal runaway occurs in a battery cell of the plurality of battery cells located within the battery module based on the temperature and the voltage of the battery cell.

According to an embodiment, the method may further include setting a first area and a second area of the battery module by dividing an entire area of the battery module based on a central battery cell provided in the battery module.

According to an embodiment, the heating device may include a first heating device provided in the first area and a second heating device provided in the second area.

According to an embodiment, the method may further include controlling the second heating device provided in the second area to generate heat when the thermal runaway of the battery cell occurs in the first area.

According to an embodiment, the method may further include controlling the first heating device provided in the first area to generate heat when the thermal runaway of the battery cell occurs in the second area.

According to an embodiment, the method may further include identifying a temperature change and a voltage change of the battery cell after an operation of the heating device is controlled.

According to an embodiment, the method may further include determining whether the temperature of the battery cell increases simultaneously in a first area and a second area of the battery module.

According to an embodiment, the method may further include monitoring the temperature of the battery cell during a specified time period of time when determining that the temperature of the battery cell increases simultaneously in the first area and the second area.

According to an embodiment, the method may further include monitoring the temperature of the battery cell during the specified time period to determine whether the temperature of the battery cell decreases.

According to an embodiment, the method may further include outputting a guidance message to a user when determining that the temperature of the battery cell does not decrease.

### BRIEF DESCRIPTION OF THE DRAWINGS

The above and other objects, features, and advantages of the present disclosure should be more apparent from the following detailed description taken in conjunction with the accompanying drawings:

FIG. 1 is a block diagram illustrating the configuration of an apparatus for controlling battery thermal management of a vehicle according to an embodiment of the present disclosure;

FIG. 2 is a diagram illustrating a battery pack according to an embodiment of the present disclosure;

FIG. 3 is a cross sectional view illustrating a battery module according to an embodiment of the present disclosure;

FIG. 4 cross sectional view illustrating a conventional battery module;

FIG. 5 is a graph illustrating a change in temperature due to thermal runaway of a conventional battery module;

FIG. 6 is a graph illustrating a change in temperature of a thermal barrier due to thermal runaway in a battery module according to an embodiment of the present disclosure;

FIG. 7 is a flowchart illustrating a method of controlling battery thermal management of a vehicle according to an embodiment of the present disclosure; and

FIG. 8 is a block diagram illustrating a computing system for executing a method according to an embodiment of the present disclosure.

### DETAILED DESCRIPTION

Hereinafter, some embodiments of the present disclosure are described in detail with reference to the drawings. In adding the reference numerals to the components of each drawing, it should be noted that identical or equivalent components are specified by the identical numeral even when they are displayed on different drawings. Further, in describing the embodiments of the present disclosure, a detailed description of the related known configurations or functions should be omitted when it is determined that it interferes with the understanding of the embodiment of the present disclosure.

When describing the components of the embodiment according to the present disclosure, terms such as first, second, A, B, (a), (b), and the like may be used. These terms are merely intended to distinguish the components from other components. The terms do not limit the nature, order, or sequence of the components. Unless otherwise defined, all terms including technical and scientific terms used herein have the same meaning as commonly understood by one of ordinary skill in the art to which this disclosure belongs. It should be further understood that terms, such as those defined in commonly used dictionaries, should be interpreted as having a meaning that is consistent with their meaning in the context of the relevant art and should not be interpreted in an idealized or overly formal sense unless expressly so defined herein.

When a component, device, element, or the like of the present disclosure is described as having a purpose or performing an operation, function, or the like, the component, device, or element should be considered herein as being “configured to” meet that purpose or perform that operation or function.

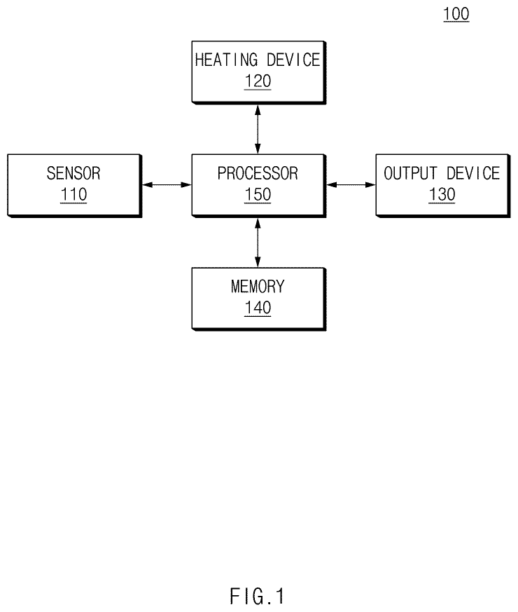

FIG. 1 is a block diagram illustrating the configuration of an apparatus for controlling battery thermal management of a vehicle according to an embodiment of the present disclosure.

As shown in FIG. 1, an apparatus 100 for controlling battery thermal management of a vehicle may include a sensor 110, a heating device 120, an output device 130, a memory 140, and a processor 150.

The sensor 110 may include a temperature sensor for obtaining a temperature of each battery cell in a battery module and a voltage sensor for obtaining a voltage of each battery cell.

The heating device 120 may generate heat under control of the processor 150 such that the temperature of the battery cell rises to a specified temperature or above. According to an embodiment, the heating device 120 may generate enough heat to cause thermal runaway to occur in the battery cell. According to an embodiment, the heating devices 120 may be provided, i.e., disposed, in a first area and a second area set by the processor 150 within a battery module, respectively.

The output device 130 may output an image or sound under control of the processor 150. According to an embodiment, the output device 130 may be implemented as a display device or a sound output device. In this case, the display device may include a HUD, a cluster, and the like. According to an embodiment, the display device may be implemented as a display employing a liquid crystal display (LCD) panel, a light emitting diode (LED) panel, an organic light emitting diode (OLED) panel, a plasma display panel (PDP), or the like. A liquid crystal display may include a thin film transistor liquid crystal display (TFT-LCD). The display device may be implemented integrally with a touch screen panel (TSP).

The memory 140 may store at least one algorithm for performing calculation or execution of various commands for operation of an apparatus for controlling battery thermal management of a vehicle according to an embodiment of the present disclosure. According to an embodiment, the memory 140 may store at least one command or computer executable instruction executed by the processor 150. The command may cause an apparatus for controlling battery thermal management of a vehicle according to the present disclosure to operate. The memory 140 may include at least one storage medium of a flash memory, a hard disk, a memory card, a read-only memory (ROM), a random access memory (RAM), a programmable ROM (PROM), an electrically erasable PROM (EEPROM), a magnetic memory, a magnetic disk, and an optical disk.

The processor 150 may be implemented with various processing devices in which a semiconductor chip and the like capable of performing operations or executions of various commands is embedded. The processor 150 may control operations of an apparatus for controlling battery thermal management of a vehicle according to an embodiment of the present disclosure. The processor 150 may be electrically connected to the sensor 110, the heating device 120, the output device 130, and the memory 140 through a wired cable or various circuits to transmit electrical signals including control commands and the like. The processor 150 may execute operations or data processing related to control and/or communication. The processor 150 may include at least one of a central processing unit, an application processor, a communication processor (CP), or a combination thereof.

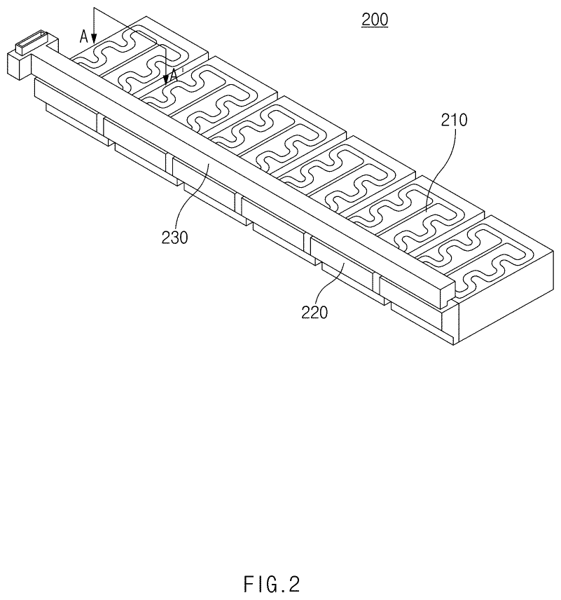

The processor 150 may divide the battery module into a first area and a second area based on the location (center position) of a central battery cell within the battery module. In addition, when the processor 150 determines that thermal runaway has occurred in a battery cell located within the battery module based on the temperature and voltage of the battery cell, the processor 150 may control operations of the heating device 120 based on the location of a battery cell of the plurality of battery cells in which the thermal runaway occurs in the battery module. To this end, the structures of a battery pack and a battery module according to an embodiment of the present disclosure are described below with reference to FIGS. 2 to 4.

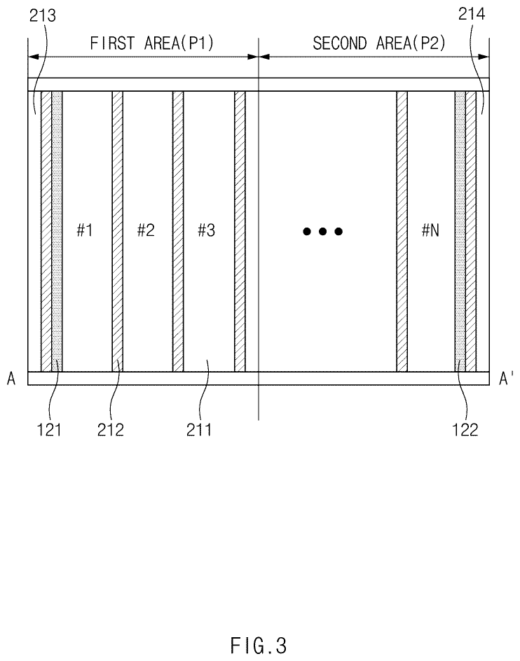

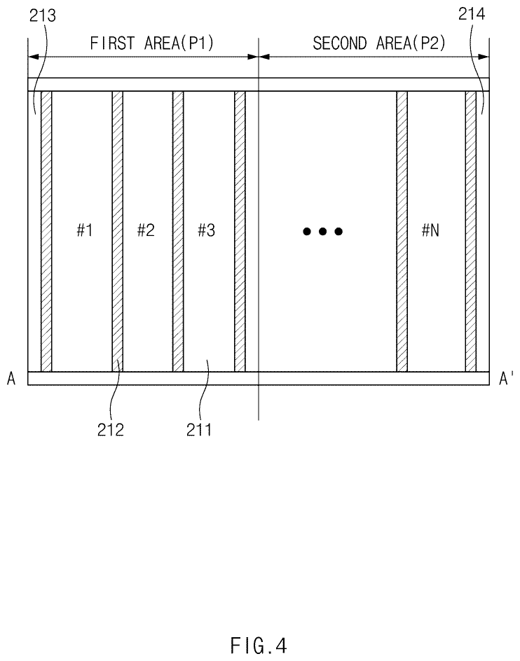

FIG. 2 is a diagram illustrating a battery pack according to an embodiment of the present disclosure. FIG. 3 is a cross sectional view illustrating a battery module according to an embodiment of the present disclosure. FIG. 4 is a graph illustrating a temperature change of a thermal barrier due to thermal runaway in a battery module according to an embodiment of the present disclosure.

As shown in FIG. 2, a battery pack 200 according to an embodiment of the present disclosure may be implemented by connecting a plurality of battery modules 210. A plurality of vent guides 220 may be provided at one end of the battery module 210, and may be provided with a main ventilation box 230 connecting the vent guides 220. When the pressure of gas generated inside the battery cell included in the battery module 210 increases, the vent guide 220 may allow the gas to be discharged from the battery cell. The main ventilation box 230 may serve as a passage through which gas is discharged through the vent guide 220. A cross section of the battery module 210 taken along line A-A′ is be described below with reference to FIG. 3.

As shown in FIG. 3, the battery module 210 according to an embodiment of the present disclosure may be provided with a plurality (e.g., N) of battery cells 211. An elastomer 212 may be provided between the battery cells 211, such that the elasticity of the elastomer 212 prevents a volume change from affecting neighboring battery cells even when the volume change occurs during charging and discharging of the battery cell.

The battery module 210 includes a first heating device 121 provided adjacent to the outermost battery cell #1 in a first area P1. A second heating device 122 is provided adjacent to the outermost battery cell #N in a second area P2.

The outermost part of the battery module 210 may be provided with thermal barriers 213 and 214 to prevent thermal runaway from being transmitted to neighboring battery modules.

The processor 150 may determine whether thermal runaway occurs in the battery cell based on the temperature and voltage of the battery cell. When it is determined that thermal runaway occurs, the processor 150 may determine the location of the cell where the thermal runaway occurs based on the temperature and voltage. According to an embodiment, the processor 150 may determine that the thermal runaway occurs when the temperature of the battery cell is above a specified temperature and the voltage of the battery is above a specified voltage.

According to an embodiment, when it is determined that thermal runaway occurs in a battery cell in the first area P1, the processor 150 may control the second heating device 122 provided in the second area P2 to generate heat.

According to an embodiment, when the processor 150 activates the second heating device 122 to generate heat, the second heating device 122 may generate heat and cause thermal runaway to occur in the battery cell #N. When thermal runaway occurs in the battery cell #N due to heat generated by the second heating device 122, the thermal runaway may spread to the battery cell #N-1 adjacent to the battery cell #N. In addition, the temperature of the second thermal barrier 214 may also increase due to the heat generated by the second heating device 122.

According to an embodiment, when it is determined that thermal runaway occurs in the battery cell in the second area P2, the processor 150 may control the first heating device 121 provided in the first area P1 to be activated and generate heat.

According to an embodiment, when the processor 150 controls the first heating device 121 to be activated and generate heat, the first heating device 121 may generate heat to cause the thermal runaway in the battery cell #1 in the first area P1. When thermal runaway occurs in the battery cell #1 due to heat generated by the first heating device 121, the thermal runaway may spread to the battery cell #2 adjacent to the battery cell #1. In addition, the temperature of the first thermal barrier 213 may also increase due to the heat generated by the first heating device 121.

In order to compare the increase in temperature of the thermal barrier due to the heat generated by the activated heating device according to an embodiment of the present disclosure with the increase in temperature of the thermal barrier due to the thermal runaway in a conventional battery module, embodiments are described with reference to a cross section of a conventional battery module and a change in temperature of a battery cell due to the thermal runaway.

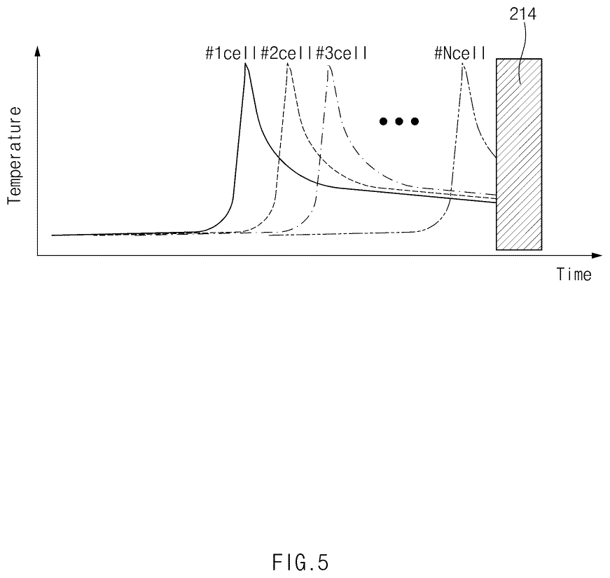

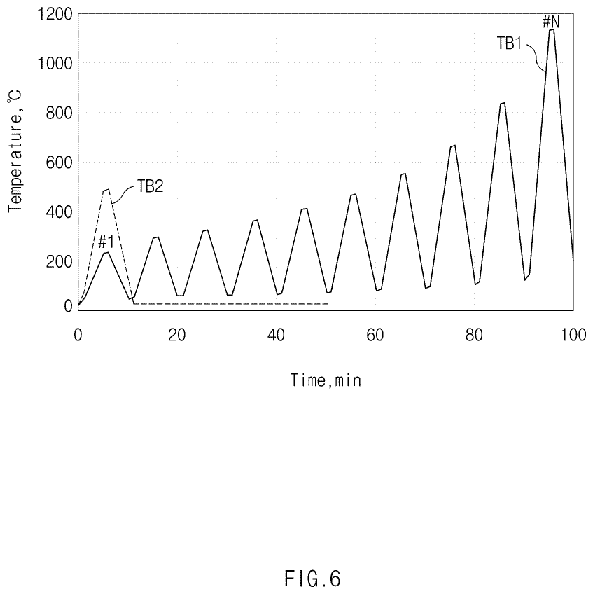

FIG. 4 is a cross sectional view of a conventional battery module. FIG. 5 is a graph illustrating a change in temperature due to thermal runaway of a conventional battery module. FIG. 6 is a graph illustrating a change in temperature of a thermal barrier due to thermal runaway in a battery module according to an embodiment of the present disclosure.

As shown in FIG. 4, a conventional battery module does not have a heating device at a periphery outside the battery module. Therefore, for example, when thermal runaway occurs in the battery cell #1, the temperature of the battery cell #1 increases. In addition, as the temperature of the battery cell #1 increases, the temperature of the thermal barrier 214 may also increase. Because the thermal runaway of the battery cell #1 spreads to the battery cell #2, as shown in FIG. 5, heat from battery cell #1 may trigger the thermal runaway in the battery cell #2. As shown in FIG. 5, when thermal runaway spreads to a neighboring battery cell and the temperature of the battery cell #N increases, the temperature of the battery cell #N may increase significantly more than the increased temperature of the thermal barrier 214 due to the heat accumulated from battery cell #1 to battery cell #N.

Therefore, as shown in FIG. 6, as thermal runaway spreads from the battery cell #1 to the battery cell #N, the temperature TB1 of the thermal barrier 214 continues to rise. In this case, the temperature of the battery module itself may increase so that thermal runaway spreads to neighboring battery modules.

According to an embodiment of the present disclosure, when thermal runaway occurs in the battery cell #1, the processor 150 may simultaneously activate the second heating device 122 provided in the second area P2 to generate heat, so that the temperature TB2 of thermal barrier 214 rapidly rises due to the heat generated by the second heating device 122. When a thermal runaway occurs in the battery cell #1, the direction of thermal runaway is reversed by artificially heating the battery cell #N in a simultaneous manner. Therefore, the spread of thermal runaway to neighboring battery modules may be fundamentally prevented.

Accordingly, according to an embodiment of the present disclosure, it is possible to design a lightweight thermal barrier provided at the outermost part of the battery module and reduce material costs. In addition, it is possible to increase the driving distance by reducing the weight of a vehicle.

In addition, even when thermal runaway spreads from the battery cell #1 into the second area P2, the battery cell #N is burned by the heat generated by the second heating device 122. Therefore, the thermal runaway does not spread any further since there are no longer substances to be burned along the path from the battery cell #1 to the battery cell #N.

The processor 150 may identify the temperature and voltage changes of each battery cell after the heating device is activated.

According to an embodiment of the present disclosure, when thermal runaway of the battery cell occurs in the first area P1, the temperature of the battery cell in the first area P1 increases. When the heating device in the second area P2 is activated and generates heat due to the thermal runaway of the battery cell in the first area P1, the temperature of the battery cell in the second area P2 increases, so the processor 150 may determine whether the temperatures of the battery cells in the first area and the second area increase.

When it is determined that the temperatures of the battery cells in the first area and the second area increase, the processor 150 may predict that the temperature of the battery module will no longer increase. To this end, the processor 150 may monitor the temperature and voltage of each battery cell in the battery module.

When a specified time elapses after the heating device is activated and generates heat, the processor 150 may determine whether the temperature of the battery cell in the battery module decreases. In this case, the specified time may correspond to the time required for all battery cells in the battery module to burn.

When the processor 150 determines that the temperature of the battery cell in the battery module decreases after a specified time elapses after the heating device is activated and generates heat, the processor 150 may terminate the operation.

When the processor 150 determines that the temperature of the battery cell in the battery module does not decrease after a specified time elapses after the heating device is activated and generates heat, the processor 150 may determine that thermal runaway of the battery cell in the battery module is in progress. The processor 150 may output a guidance message to a user to allow the user to recognize the guidance message.

According to an embodiment of the present disclosure, when a guidance message is output to a user, the guidance message may be output as at least one of an image, a voice, or a combination thereof through the output device 130. However, the embodiment is not limited thereto. Although not shown, the processor 150 may transmit a guidance message to a user terminal through a communication device that communicates with the user terminal such that the user recognizes the guidance message.

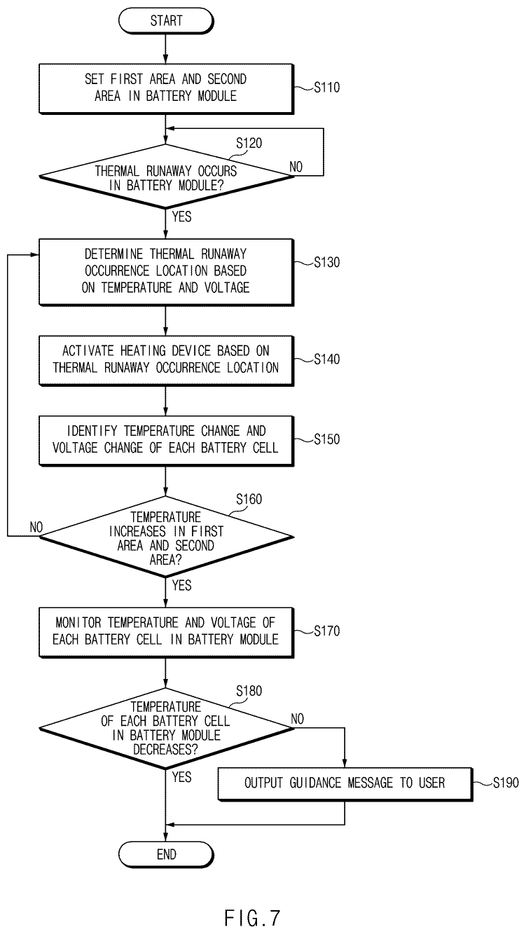

FIG. 7 is a flowchart illustrating a method of controlling battery thermal management of a vehicle according to an embodiment of the present disclosure.

As shown in FIG. 7, in operation S110, the processor 150 may set the first area and the second area of the battery module by dividing the battery module based on the location (center position) of the central battery cell within the battery module.

In operation S120, the processor 150 may determine whether thermal runaway occurs in the battery cell based on the temperature and voltage of the battery cell. According to an embodiment, in operation S120, the processor 150 may determine that the thermal runaway occurs when the temperature of the battery cell is above a specified temperature and the voltage of the battery is above a specified voltage.

When it is determined that thermal runaway of the battery cell occurs, in operation S130, the processor 150 may determine the location of the cell where the thermal runaway occurs based on the temperature and voltage.

According to an embodiment, when it is determined in operation S130 that the thermal runaway occurs in the battery cell in the first area P1, in operation S140, the processor 150 may control the second heating device 122 provided in the second area P2 to be activated and generate heat.

According to an embodiment, when the processor 150 controls the second heating device 122 to be activated and generate heat, the processor 150 may cause the second heating device 122 to generate heat, thereby causing thermal runaway to occur in the battery cell #N in the second area P2. When thermal runaway occurs in the battery cell #N due to heat generated by the second heating device 122, the thermal runaway may spread to the battery cell #N-1 adjacent to the battery cell #N. In addition, the temperature of the second thermal barrier 214 may also increase due to the heat generated by the second heating device 122.

According to an embodiment, when it is determined in operation S130 that thermal runaway occurs in the battery cell in the second area P2, in operation S140, the processor 150 may control the first heating device 121 provided in the first area P1 to be activated and generate heat.

According to an embodiment, when the processor 150 controls the first heating device 121 to be activated and generate heat, the first heating device 121 may generate heat and cause thermal runaway to occur in the battery cell #1. When thermal runaway occurs in the battery cell #1 due to heat generated by the first heating device 121, the thermal runaway may spread to the battery cell #2 adjacent to the battery cell #1. In addition, the temperature of the first thermal barrier 213 may also increase due to the heat generated by the first heating device 121.

In operation S150, the processor 150 may identify the temperature and voltage changes of each battery cell after the heating device is activated.

According to an embodiment of the present disclosure, when thermal runaway of the battery cell occurs in the first area P1, the temperature of the battery cell in the first area P1 increases. When the heating device in the second area P2 is activated and generates heat due to the thermal runaway of the battery cell in the first area P1, the temperature of the battery cell in the second area P2 increases. Therefore, the processor 150 may determine whether the temperatures of the battery cells in the first area and the second area increase in operation S160.

When it is determined in operation S160 that the temperatures of the battery cells in the first area and the second area increase, in operation S170, the processor 150 may predict that the temperature of the battery module will no longer increase. To this end, the processor 150 may monitor the temperature and voltage of each battery cell in the battery module.

When a specified time elapses after the heating device is activated and generates heat, in operation $180, the processor 150 may determine whether the temperature of the battery cell in the battery module decreases. In this case, the specified time may correspond to the time required for all battery cells in the battery module to burn.

When it is determined in operation S180 that the temperature of the battery cell in the battery module decreases after a specified time elapses after the heating device is activated and generates heat, the processor 150 may terminate the operation.

When it is determined in operation S180 that the temperature of the battery cell in the battery module does not decrease even after a specified time elapses after the heating device is activated and generates heat, in operation S190, the processor 150 may determine that thermal runaway of the battery cell in the battery module is in progress. The processor 150 may output a guidance message to a user to allow the user to recognize the guidance message.

According to an embodiment of the present disclosure, when a guidance message is output to a user in operation S190, the guidance message may be output as at least one of an image, a voice, or a combination thereof through the output device 130. However, the embodiments are not limited thereto. Although not shown, the processor 150 may transmit a guidance message to a user terminal through a communication device that communicates with the user terminal such that the user recognizes the guidance message.

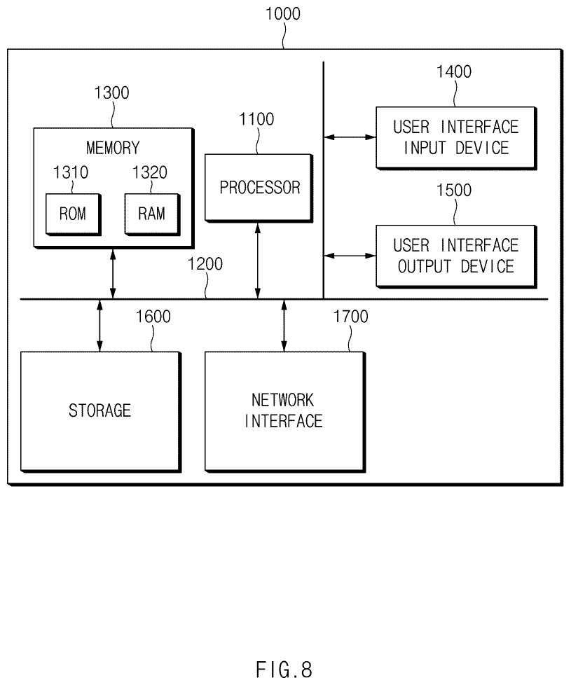

FIG. 8 is a block diagram illustrating a computing system for executing a method according to an embodiment of the present disclosure.

As shown in FIG. 8, a computing system 1000 may include at least one processor 1100, a memory 1300, a user interface input device 1400, a user interface output device 1500, storage 1600, and a network interface 1700 connected through a bus 1200.

The processor 1100 may be a central processing device (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the processes of the methods or algorithms described in relation to the embodiments of the present disclosure may be implemented directly by hardware executed by the processor 1100, a software module, or a combination thereof. The software module may reside in a storage medium (i.e., the memory 1300 and/or the storage 1600), such as a RAM, a flash memory, a ROM, an EPROM, an EEPROM, a register, a hard disk, solid state drive (SSD), a detachable disk, or a CD-ROM. The storage medium is coupled to the processor 1100. The processor 1100 may read information from the storage medium and may write information in the storage medium. In another embodiment, the storage medium may be integrated with the processor 1100. The processor and the storage medium may reside in an application specific integrated circuit (ASIC). The ASIC may reside in a user terminal. In another embodiment, the processor and the storage medium may reside in the user terminal as an individual component.

According to various embodiments of the present disclosure, the apparatus for controlling battery thermal management of a vehicle may prevent thermal runaway from spreading to neighboring battery modules even when thermal runaway occurs in a battery cell.

According to various embodiments of the present disclosure, the apparatus for controlling battery thermal management of a vehicle may include a heating device provided near a thermal barrier of a battery module. In addition, when thermal runaway occurs in a battery cell inside a battery module, the apparatus may operate the heating device located on the opposite side of the battery cell where the thermal runaway occurs to minimize thermal transfer to the thermal barrier, thereby minimizing the weight of the thermal barrier and preventing thermal runaway from spreading to surrounding battery modules.

In addition, according to various embodiments of the present disclosure, the apparatus for controlling battery thermal management of a vehicle may include a heating device provided near a thermal barrier of a battery module to prevent thermal runaway from spreading. Therefore, it is possible to minimize an increase in the thickness of the thermal barrier, thereby enabling a lightweight design of the battery module and improving vehicle fuel efficiency.

Although various embodiments of the present disclosure have been described for illustrative purposes, those of ordinary skill in the art should appreciate that various modifications, additions and substitutions are possible, without departing from the scope and spirit of the disclosure.

Therefore, the various embodiments disclosed in the present disclosure are provided for the sake of descriptions, not limiting the technical concepts of the present disclosure. It should be understood that such embodiments are not intended to limit the scope of the technical concepts of the present disclosure. The protection scope of the present disclosure should be understood by the claims below. All the technical concepts within the equivalent scopes should be interpreted to be within the scope of the right of the present disclosure.

What is claimed is:

1. An apparatus for controlling battery thermal management of a vehicle, the apparatus comprising:
at least one sensor configured to detect a temperature and a voltage of a plurality of battery cells in a battery module;
a heating device configured to generate heat; and
a processor configured to control an operation of the heating device based on a location in which a thermal runaway occurs in the battery module when the processor determines that the thermal runaway occurs in a battery cell of the plurality of battery cells located within the battery module based on the temperature and the voltage of the battery cell.

2. The apparatus of claim 1, wherein the processor is configured to set a first area and a second area of the battery module by dividing an entire area of the battery module based on a central battery cell provided in the battery module.

3. The apparatus of claim 2, wherein the heating device includes a first heating device provided in the first area and a second heating device provided in the second area.

4. The apparatus of claim 3, wherein the processor is configured to control the second heating device provided in the second area to generate heat when the thermal runaway of the battery cell occurs in the first area.

5. The apparatus of claim 3, wherein the processor is configured to control the first heating device provided in the first area to generate heat when the thermal runaway of the battery cell occurs in the second area.

6. The apparatus of claim 1, wherein the processor is configured to identify a temperature change and a voltage change of the battery cell after an operation of the heating device is controlled.

7. The apparatus of claim 6, wherein the processor is configured to determine whether the temperature of the battery cell increases simultaneously in a first area and a second area of the battery module.

8. The apparatus of claim 7, wherein the processor is configured to monitor the temperature of the battery cell during a specified time period of time when determining that the temperature of the battery cell increases simultaneously in the first area and the second area.

9. The apparatus of claim 8, wherein the processor is configured to monitor the temperature of the battery cell during the specified time period to determine whether the temperature of the battery cell decreases.

10. The apparatus of claim 9, wherein the processor is configured to control an output device of the vehicle to output a guidance message to a user when determining that the temperature of the battery cell does not decrease.

11. A method of controlling battery thermal management of a vehicle, the method comprising:
detecting a temperature and a voltage of a plurality of battery cells in a battery module; and
controlling an operation of a heating device based on a location in which a thermal runaway occurs in the battery module when determining that the thermal runaway occurs in a battery cell of the plurality of battery cells located within the battery module based on the temperature and the voltage of the battery cell.

12. The method of claim 11, further comprising:
setting a first area and a second area of the battery module by dividing an entire area of the battery module based on a central battery cell provided in the battery module.

13. The method of claim 12, wherein the heating device includes a first heating device provided in the first area and a second heating device provided in the second area.

14. The method of claim 13, further comprising:
controlling the second heating device provided in the second area to generate heat when the thermal runaway of the battery cell occurs in the first area.

15. The method of claim 13, further comprising:
controlling the first heating device provided in the first area to generate heat when the thermal runaway of the battery cell occurs in the second area.

16. The method of claim 11, further comprising:
identifying a temperature change and a voltage change of the battery cell after an operation of the heating device is controlled.

17. The method of claim 16, further comprising:
determining whether the temperature of the battery cell increases simultaneously in a first area and a second area of the battery module.

18. The method of claim 17, further comprising:
monitoring the temperature of the battery cell during a specified time period of time when determining that the temperature of the battery cell increases simultaneously in the first area and the second area.

19. The method of claim 18, further comprising:
monitoring the temperature of the battery cell during the specified time period to determine whether the temperature of the battery cell decreases.

20. The method of claim 19, further comprising:
outputting a guidance message to a user when determining that the temperature of the battery cell does not decrease.
